(19) United States
(12) Patent Application Publication
(10) Pub. No.: US 2005/0163546 A1
(43) Pub. Date: Jul. 28, 2005

(54) Image reading apparatus having automatic document feeder

(76) Inventor: Won-Taek Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/934,472

(22) Filed: Sep. 7, 2004

(30) Foreign Application Priority Data
Jan. 28, 2004 (KR) 2004-5526

(51) Int. Cl. G03G 15/00

(52) U.S. Cl. 399/367

(57) ABSTRACT

An image reading apparatus provided with an automatic document feeder include a main body provided with an image reading part on one surface thereof, a document feeder main body installed on one side of the main body and provided with a document loading unit to load at least one document and a document conveying path formed therein to allow the document of the document loading unit to pass through the image reading part, a document conveying unit mounted on the document feeder main body to convey the document along the document conveying path, a document guide sheet mounted on the document feeder main body on the document conveying path, and an image reading unit installed in the main body to read an image of the document passing through the image reading part.

### CROSS-REFERENCE TO RELATED APPLICATIONS

This application claims the benefit of Korean Patent Application No. 2004-5526, filed Jan. 28, 2004, the disclosure of which is hereby incorporated herein by reference in its entirety.

### BACKGROUND OF THE INVENTION

1. Field of the Invention

The present general inventive concept relates to an image reading apparatus, and more particularly, to an image reading apparatus having an automatic document feeder.

2. Description of the Related Art

Recently, an image reading apparatus, such as a copier, a scanner, a multifunction machine with a scanning function, or so forth, is provided with an automatic document feeder for automatically feeding loaded documents one by one.

Such an automatic document feeder has been widely employed since it sequentially feeds documents one by one so as to enable a copying or scanning operation automatically to be carried out, even when a user simply loads the documents.

Especially, a feeding speed of the automatic document feeder has been recently increased. Since this automatic document feeder allows the coping or scanning operation of the document to be very rapidly carried out, it is in the spotlight.

As an example of the automatic document feeder, Japanese Patent Publication No. P10-72141 published on Mar. 17, 1998 discloses an automatic document conveyor.

In accordance with the above-mentioned Japanese patent publication, a conventional automatic document feeder is mounted on an upper part of a copier and includes a document loading unit for loading a plurality of documents, a driven roller and a feeding belt for feeding the loaded document, a first conveying roller for conveying the fed document, an inverting guide for guiding the document conveyed by the first conveying roller to be disposed on a slit glass, through which image reading is performed, an inverted paper discharging guide for guiding the document passing the slit glass to a paper discharging path, a reflecting guide plate installed on an upper side of a center of the inverting guide and the inverted paper discharging guide to guide the document to maintain a constant distance between the document and the slit glass when the document passes the slit glass, a second conveying roller and a discharging roller for discharging the document guided along the paper discharging path to an outside thereof, and a document discharging frame provided to load the discharged document.

Therefore, when the document is loaded on the document loading unit, the conventional automatic document feeder automatically feeds the loaded document toward the slit glass using the driven roller and the feeding belt. The copier provided with the automatic document feeder automatically performs a copying operation by reading an image of the document passing along the slit glass using an image reading means installed therein.

Although this automatic document feeding operation of the conventional automatic document feeder and the copier having the same may be performed to read the image of the document in a case of a low feeding speed, the conventional automatic document feeder has considerable difficulties in precisely reading the image of the document when a feeding speed is changed from the low feeding speed to a high feeding speed.

Specifically, the document should not be shaken during passing through an image reading region of the slit glass, at which the image reading operation of the document is performed. Since the conventional automatic document feeder has a discontinuous region, such as a gap between an inverting guide and the slit glass placed on the conveying path of the document, the conventional automatic document feeder has a problem in that the document is shaken when the document passes through the image reading region of the slit glass as an entering shock of the document is generated at the discontinuous region when the document is conveyed at a high speed, that is, when the feeding speed (moving speed) of the document is changed to the high speed. Therefore, the conventional automatic document feeder has a problem in that the image of the document is distorted from its original image when the image reading means reads the shaking image of the document.

### SUMMARY OF THE INVENTION

In order to solve the foregoing and/or other problems, it is an aspect of the present general inventive concept to provide an image reading apparatus provided with an automatic document feeder capable of preventing the document from shaking.

It is another aspect of the present general inventive concept to provide an image reading apparatus provided with an automatic document feeder capable of increasing the quality of a reading image.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image reading apparatus including a main body provided with an image reading part on one surface thereof, a document feeder main body installed on one side of the main body and provided with a document loading unit to load at least one document and a document conveying path formed therein to allow the document of the document loading unit to pass through the image reading part, a document conveying unit mounted on the document feeder main body to convey the document along the document conveying path, a document guide sheet mounted on the document feeder main body along the document conveying path, and an image reading unit installed in the main body to read an image of the document passing through the image reading part.

According to an aspect of the present general inventive concept, the document guide sheet can include one end fixedly coupled to the document feeder main body and the other end extended to an end of the image reading part.

According to another aspect of the present general inventive concept, the document feeder main body can include a lower frame installed on both sides of the image reading part to guide the document, and an upper frame installed to be spaced-apart from the lower frame by a predetermined distance, and the document guide sheet can be fixedly coupled to the upper frame.

According to yet another aspect of the present general inventive concept, the document conveying unit can include an image reading roller mounted on the document feeder main body within the document conveying path so as to convey the document conveyed along the document conveying path toward the image reading part, and the document guide sheet can be fixedly coupled to the upper frame between the image reading roller and the image reading part.

According to still another aspect of the present general inventive concept, the document guide sheet can be formed of a flexible material. For example, the document guide sheet can be made of any one of PVC, PET and PC.

According to another aspect of the present general inventive concept, the document guide sheet can have a thickness of 0.1 mm to 0.2 mm. Further, the document guide sheet can be wider than that of the document. The document guide sheet can have a surface of a white color.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating an image reading apparatus in accordance with an embodiment of the present general inventive concept;

FIG. 2 is an enlarged cross-sectional view illustrating a portion A of FIG. 1;

FIG. 3 is a cross-sectional view illustrating a state that a document is conveyed in the image reading apparatus of FIG. 2; and

FIG. 4 is a cross-sectional view illustrating an image reading apparatus in accordance with another embodiment the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

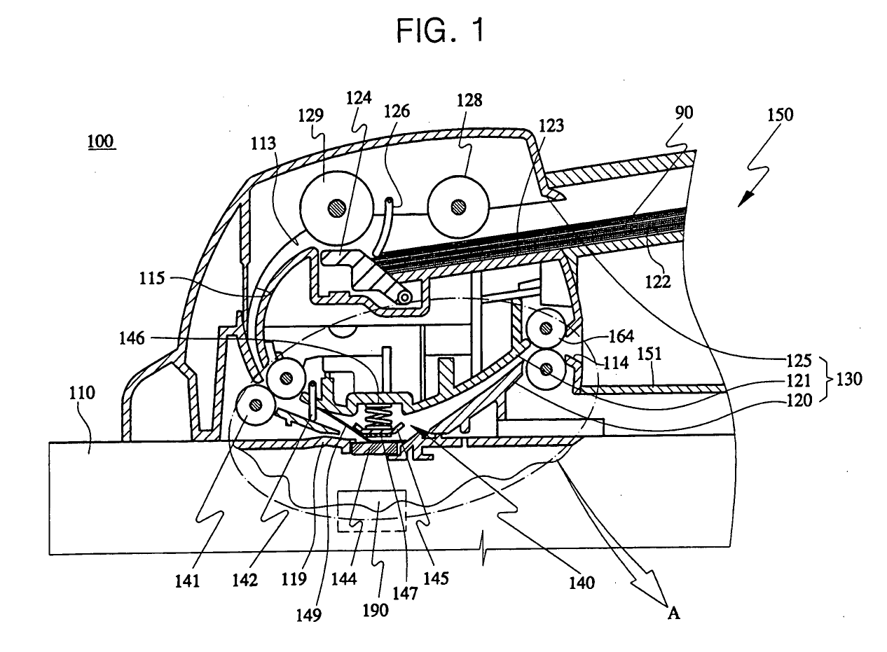

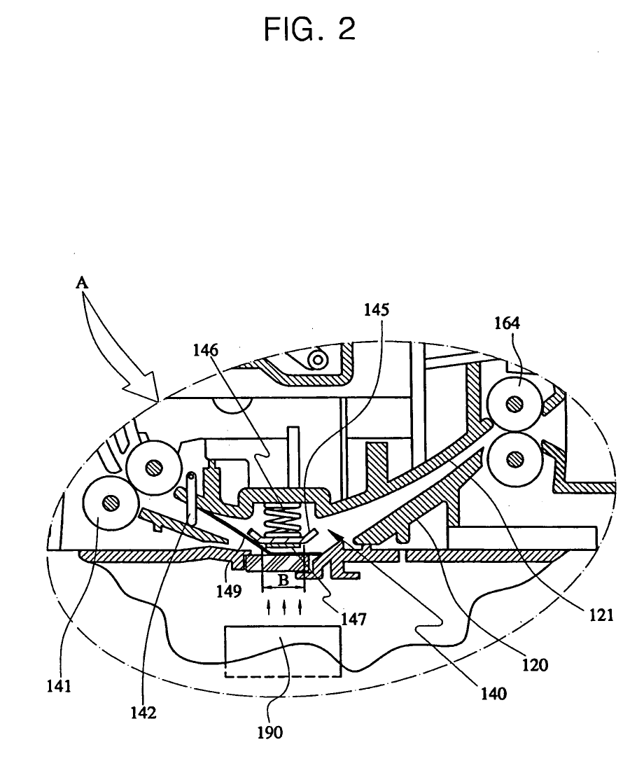

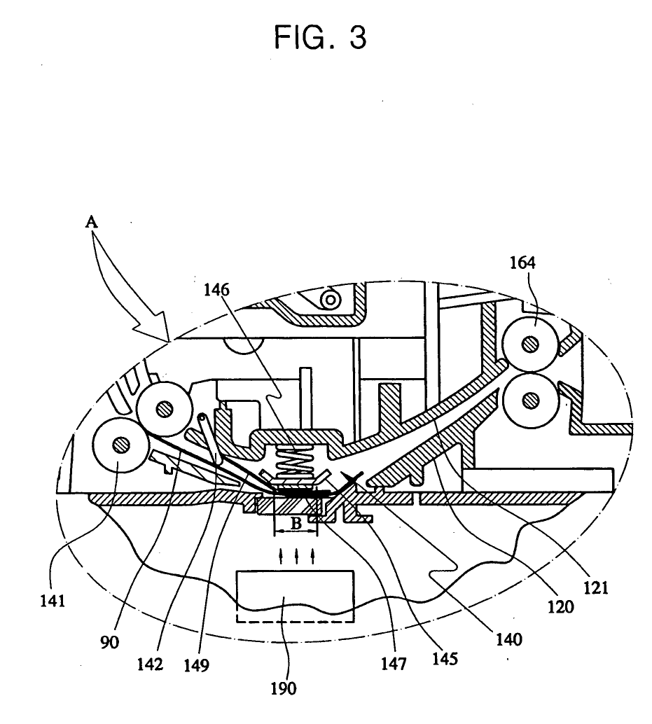

FIG. 1 is a cross-sectional view illustrating an image reading apparatus 100 according to an embodiment of the present general inventive concept, FIG. 2 is an enlarged cross-sectional view illustrating a portion A of FIG. 1, and FIG. 3 is a cross-sectional view illustrating a state that a document is conveyed in the image reading apparatus of FIG. 2. Referring to FIGS. 1-3, the image reading apparatus 100 may include a main body 110 provided with an image reading part 144 thereon, an automatic document feeder 150 to automatically feed a document 90 to the image reading part 144 of the main body 110, an image reading unit 190 to read an image of the document 90 automatically fed by the automatic document feeder 150, and a controller (not shown) to control the image reading apparatus. At this time, the automatic document feeder 150 can be installed on an upper part of the image reading part 144 formed on the main body 110, and the image reading unit 190 can be installed on a lower side of the image reading part 144, i.e., an inner part of the main body 110.

More specifically describing, the image reading part 144 installed on the main body 110 is embodied as a document reading glass 144 through which the image reading unit 190 installed on the lower side of the image reading part 144 reads the image of the document 90. A guide frame 119 can be installed on both sides of the document reading glass 144 to guide the document 90 conveyed toward the document reading glass 144 so that the document 90 passes the document reading glass 144.

The automatic document feeder 150 can include a document feeding frame 122 to load the document to be fed, a document feeder main body 130 provided with a document conveying path 115 having a document inlet 113 and a document outlet 114 formed on an upper side and a lower side thereof, respectively, to make the document on the document feeding frame 122 pass the document reading glass 144, a document conveying unit to sequentially convey the document 90 along the document conveying path 115, a document detecting unit to detect a position of the document 90 conveyed by the document conveying unit, a document pressing unit 140 to guide and press the document to be in close contact with the document reading glass 144, a document shaking prevention unit to prevent the document 90 conveyed to the document reading glass 144 from shaking, and a document discharge frame 151 to load (discharge) the document 90 passing through the document reading glass 144.

The document feeding frame 122 can be formed in a plate structure to load a plurality of documents 90, can be installed on one side of the document feeder main body 130, and can slope with respect to the document feeder main body 130 at a predetermined angle such that the loaded document 90 is automatically aligned.

The document feeder main body 130 can include a lower frame 120 installed on a lower side of the document conveying path 115, an upper frame 121 installed on an upper side of the document conveying path 115, and a cover 125 to cover both the lower and upper frames 120 and 121. The lower frame 120 can be installed on both sides of the guide frame 119 and can guide the document 90 to smoothly convey to and pass through the document reading glass 144. The upper frame 121 can be spaced apart from the lower frame 120 to form the document conveying path 115 between the upper frame 121 and the lower frame 120, and a document loading unit 123 can be installed on an upper surface of the document feeding frame 122 to load the document 90 to be conveyed along the document conveying path 115. At this time, the document loading unit 123 can slope at a predetermined angle like the document feeding frame 122, and can be connected to an end of the document feeding frame 122. In addition, a document aligning member 124, can slope at a predetermined angle in an opposite direction of the document loading unit 123 such that the document loaded by the document loading unit 123 is automatically aligned, and can be installed on an inner end of the document loading unit 123, i.e., a position where the document conveying path 115 starts. At this time, the document aligning member 124 can hinge on the upper frame 121 to be movable up and down with respect to the upper frame 121 by a predetermined distance. Therefore, the document 90 loaded on the document feeding frame 122 and the document loading unit 123 can be sequentially and automatically aligned by the document aligning member 124 at the position where the document conveying path starts. Further, the cover 125 can be engaged with the lower frame 120 to be opened and closed. Therefore, when a jam of the document 90, etc., is generated on the document conveying path 115, an operator can easily eliminate the document 90 after opening the cover 125.

The document conveying unit can include a plurality of rollers mounted on the document feeder main body 130 to convey the document 90. That is, the document conveying unit can include a pick-up roller 128 installed on an upper side of the document loading unit 123 to be movable to up and down to pick-up the document 90 loaded on the document loading unit 123 toward the document conveying path 115, a feed roller 129 installed on an upper side of the document aligning member 124 to feed the picked-up document 90 to an inner side of the document conveying path 115, an image reading roller 141 installed between the document reading glass 144 and the feed roller 129 within the document conveying path 115 to convey the document 90 fed by the feed roller 129 toward the document reading glass 144, and a discharge roller 164 installed between the document reading glass 144 and the document outlet 114 within the document conveying path 115 to discharge the document 90 passing through the document reading glass 144 toward an outside thereof.

The document detecting unit can include a document detecting sensor 126 installed on a front side of the feed roller 129 to detect whether the document 90 is loaded thereon, and a document reading sensor 142 installed between the image reading roller 141 and the document reading glass 144 to check a reading point of the document 90. As a result, the controller can calculate a precise timing of conveyance and reading of the document 90 using signals of the document detecting and reading sensors 126 and 142.

The document pressing unit 140 can maintain a distance between the document 90 and the document reading glass 144 uniformly, and can include a white bar 145 having an upper side movably installed on the upper frame 121 of the document feeder main body 130 to be spaced apart from the document reading glass 144, a white bar spring 146 interposed between the white bar 145 and the upper frame 121 to move the white bar 145 up and down with respect to the document reading glass 144 by a predetermined distance, and a white sheet 147 of a white color and mounted on a lower side of the white bar 145 to eliminate a dark part of both sides of the document 90 during reading an image of the narrow document 90. As a result, the document 90 passing through the document conveying path 115 can be uniformly maintained a distance with the document reading glass 144 by the document pressing unit 140 regardless of a thickness of the document 90.

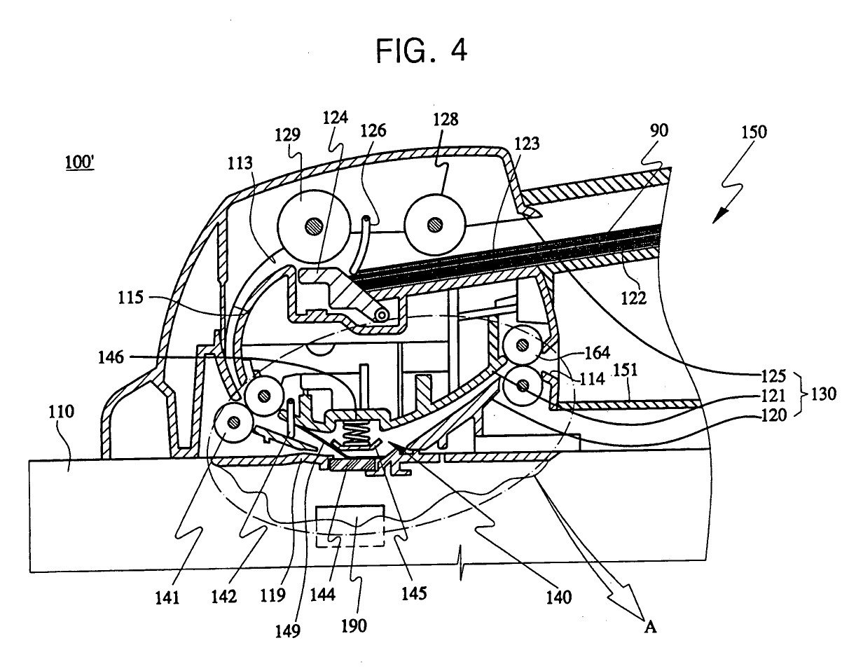

The document shaking prevention unit can prevent the document 90 from shaking when the document 90 conveyed to the document reading glass 144 is conveyed at a high-speed or low-speed, and can be embodied as a document guide sheet 149 installed on an upper part of the document reading glass 144 within the document conveying path 115. That is, the document guide sheet 149 can be fixedly coupled to the upper frame 121 located on the upper side of the document conveying path 115, wherein only one end of the document guide sheet 149 is fixedly coupled to the upper frame 121 to serve to guide the document 90. As a result, the shaking of the document 90 conveyed to the document reading glass 144 can be prevented since the document guide sheet 149 guides the document 90. At this time, the one end of the document guide sheet 149 can be fixedly coupled to the upper frame 121 located between the image reading roller 141 and the document reading glass 144, and the other end thereof can be extended to an end (a portion) of the document reading glass 144, i.e., an image reading region B shown in FIG. 2. In addition, the document guide sheet 149 can be made of a flexible material having a thin thickness to smoothly guide the document 90. For example, the document guide sheet 149 can be formed of a PVC (Polyvinyl chloride), PET (Polyester), PC (polycarbonate), etc., having a thickness of 0.1 mm˜0.2 mm. In addition, the document guide sheet 149 can be wider than that of a maximum width of the conveyable document 90 by a predetermined width in a direction parallel and/or perpendicular to the document conveying path 115 such that the shaking of end portions of the document 90 can be minimized. Further, a surface of the document guide sheet 149 can have a surface of the same white color as the white sheet 147 according to an aspect of the present general inventive concept. In this case, the document guide sheet 149 can also function as the white sheet 147 mounted to eliminate a dark part of both sides of the document 90 during reading the image of the narrow document 90. Therefore, the automatic document feeder 150 may not have the white sheet 147 of FIG. 2 according to another aspect of the present general inventive concept, as shown in FIG. 4.

A movement of the document guide sheet 149 with respect to the document reading glass 144 can be limited to a distance between the document reading glass 144 and the white bar 145 or the white sheet 147 according to a thickness of the document 90. When the document guide sheet 149 is lifted up by the document 90 fed on the document reading glass 144, the white bar 145 can control the document guide sheet 149. The document guide sheet 149 can be elastically press the document 90 toward the document reading glass 149.

The document discharge frame 151 can be installed in the vicinity of the document outlet 114 to load the document 90 passing through the document reading glass 144.

On the other hand, the image reading unit 190 can read the image of the document 90 passing through the image reading part 144, i.e., the document reading glass 144, and can include a lighting unit (not shown) to brightly light the document 90, and an image reading sensor (not shown) to photograph the image of the document 90 lighted by the lighting unit. At this time, the image reading sensor may employ an image sensor, such as a CIS (Contact image sensor) or a CCD (Charge coupled device).

Hereinafter, operations and effects of the image reading apparatus (100,100′) provided with an automatic document feeder in accordance with the present invention will be specifically described with reference to FIGS. 1 to 4.

First, an operator loads a plurality of document 90 on the document feeding frame 122 and the document loading unit 123 to read the image of the document 90. Then, the document 90 loaded on the document feeding frame 122 and the document loading unit 123 can be automatically aligned by the document aligning member 124 due to a slope of the document feeding frame 122 and the document loading unit 123.

Next, when the document 90 is completely loaded thereon, the pick-up roller 128 can pick-up the loaded document 90 and convey the picked-up document 90 toward the document conveying path 115. Then, the document 90 can be conveyed to the upper side of the document aligning member 124.

Next, when the document 90 is conveyed toward the upper side of the document aligning member 124, the feed roller 129 can convey the document 90 placed on the upper side of the document aligning member 124 to the inner side of the document conveying path 115.

Next, when the document 90 can be conveyed to the inner side of the document conveying path 115, the image reading roller 141 can convey the conveying document 90 toward the document reading glass 144. When the document 90 is conveyed toward the document reading glass 144, the document 90 can be conveyed to be in closely contact with the document reading glass 144 without any shaking during being conveyed toward the document reading glass 144 since the document guide sheet 149 is installed between the image reading roller 141 and the document reading glass 144 to prevent the document 90 from shaking.

Next, when the document 90 passes along an upper surface of the document reading glass 144 as the document 90 is conveyed by the image reading roller 141, the image reading unit 190 installed on a lower side of the document reading glass 144 can read the image of the document 90 passing along the document reading glass 144.

Finally, the document 90 read by the image reading unit 190 can be conveyed to the discharge roller 164 along the document conveying path 115, and the discharge roller 164 can discharge the document 90 through the document outlet 114. Thus, the document 90 can be loaded on the document discharge frame 151, and the image reading operation can be completed.

As described above, since the image reading apparatus in accordance with the present general inventive concept is provided with the document shaking prevention unit, i.e., the document guide sheet, on the upper side of the document reading glass to prevent the shaking of the document passing along the document reading glass, the document passing along the document reading glass can be guided by the document guide sheet to pass through the image reading region while being in contact with the document reading glass without shaking on the upper side of the document reading glass. Therefore, the image reading apparatus of the present general inventive concept has advantages capable of preventing a distortion of the image occurring in a conventional image reading apparatus from generating, and reading the high-quality image since the document can pass through the image reading region without shaking.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An image reading apparatus comprising:
a main body having an image reading part formed on one surface thereof;
a document feeder main body installed on one side of the main body and provided with a document loading unit to load at least one document and a document conveying path formed therein to allow the document of the document loading unit to pass through the image reading part;
a document conveying unit mounted on the document feeder main body to convey the document along the document conveying path;
a document guide sheet mounted on the document feeder main body to guide the document to the image reading part along the document conveying path; and
an image reading unit installed in the main body to read an image of the document passing through the image reading part.

2. The image reading apparatus according to claim 1, wherein the document guide sheet comprises a first end fixedly coupled to the document feeder main body and a second end extended from the first end to an end of the image reading part.

3. The image reading apparatus according to claim 2, wherein:
the document feeder main body comprises a lower frame installed on both sides of the image reading part to guide the document and an upper frame installed to be spaced apart from the lower frame by a predetermined distance to form the document conveying path; and
the first end of the document guide sheet is fixedly coupled to the upper frame.

4. The image reading apparatus according to claim 3, wherein:
the document conveying unit comprises an image reading roller mounted on the document feeder main body within the document conveying path so as to convey the document along the document conveying path toward the image reading part; and
the first end of the document guide sheet fixedly coupled to the upper frame is disposed between the image reading roller and the image reading part.

5. The image reading apparatus according to claim 4, wherein the document guide sheet is formed of a flexible material.

6. The image reading apparatus according to claim 4, wherein the document guide sheet is made of one of PVC, PET and PC.

7. The image reading apparatus according to claim 4, wherein the document guide sheet has a thickness of 0.1mm to 0.2mm.

8. The image reading apparatus according to claim 4, wherein the document guide sheet is wider than that of the document in a direction perpendicular to a document conveying direction of the document conveying path.

9. The image reading apparatus according to claim 4, wherein the document guide sheet comprises a surface of a white color.

10. An image reading apparatus comprising:
a main body having a guide frame and an image reading part disposed on the guide frame;
a document feeder main body having a first frame and a second frame, having a document conveying path formed between the first frame and the second frame, and having an opening formed on the second frame to communicate with the image reading part of the main body; and
a document guide sheet having a first end connected to the first frame and a second end extended from the first end in a document feeding direction along the document conveying path toward the image reading part.

11. The image reading apparatus according to claim 10, further comprising:
a document pressing unit mounted on the first frame to elastically limit a movement of the document guide sheet with respect to the image reading part.

12. The image reading apparatus according to claim 11, wherein the second end of the document guide sheet comprises a portion parallel to the image reading part, and the document pressing unit comprises a second portion parallel to the image reading part.

13. The image reading apparatus according to claim 10, further comprising:
a document pressing unit having a bar and an elastic member having one end connected to the first frame and the other end connected to the bar so that the bar elastically maintains a distance with the image reading part according to a thickness of a document.

14. The image reading apparatus according to claim 13, wherein the bar is disposed parallel to the image reading part, and a portion of the document guide sheet is disposed parallel to the image reading part.

15. The image reading apparatus according to claim 13, wherein the document pressing unit further comprises:
a sheet attached to the bar and having a surface of a white color to face the image reading part.

16. The image reading apparatus according to claim 13, wherein the bar presses the document fed along the document conveying path while the document guide sheet guides the document so that end portions of the document in a widthwise direction is not shaken on the image reading part.

17. The image reading apparatus according to claim 13, wherein the image reading part comprises an image region through which an image of the document fed along the document conveying path is read, and the bar comprises a portion corresponding to the image region of the image reading part.

18. The image reading apparatus according to claim 17, wherein the document feeder main body comprises an image reading roller to feed the document toward the image reading part along the document conveying path, and the first end of the document guide sheet is disposed between the image reading roller and the document pressing unit.

19. The image reading apparatus according to claim 10, wherein the document guide sheet has a width greater than a width of a document in a direction perpendicular to the document conveying path.

20. An image reading apparatus comprising:
a main body having an image reading part;
a document feeder main body disposed on the main body, having a first frame and a second frame to form a document conveying path therebetween, and having a document pressing unit connected to a portion of the first frame corresponding to the image reading part and elastically spaced-apart from the image reading part by a distance according to a document to be conveyed to and disposed on the image reading part along the document conveying path; and
a document guide sheet having one end connected to the first frame and the other end extended from the one end toward the second frame along the document conveying path to elastically move between the image reading part and the document pressing unit.
